(19) United States
(12) Patent Application Publication
(10) Pub. No.: US 2007/0083829 A1
(43) Pub. Date: Apr. 12, 2007

(54) Application program initiation with initial display selection

(75) Inventors: Christina Karen Lauridsen, Austin, TX (US); Hypatia Rojas, Round Rock, TX (US); Elena Schneider, Austin, TX (US)

Correspondence Address: IBM CORPORATION, PO BOX 12195, DEPT YXSA, BLDG 002, RESEARCH TRIANGLE PARK, NC, 27709, US

(73) Assignee: International Business Machines Corporation, Armonk, NY (US)

(21) Appl. No.: 11/247,763

(22) Filed: Oct. 11, 2005

(51) Int. Cl. G06F 17/00

(52) U.S. Cl. 715/847; 715/825

(57) ABSTRACT

A computer system, method and program are provided which offer a user a simple way to access alternatives to the “home page” web site on initiating operation of a browser program. In particular, a browser program in accordance with this invention offers a user the option of opening a session directly to the preselected “home page” web site or displaying a list of alternatives from which the user may select another web site as the site accessed as the browser program initiates. With other application programs, the alternatives may be such as providing a user with the option of selecting a particular document to open in a word processing program or a particular mail server for an email program.

### FIELD AND BACKGROUND OF INVENTION

There are many types of commonly used programs with computer systems such as workstations. One such program is known as a web browser. Such programs, including by way of example and not limitation Microsoft Internet Explorer, Netscape Navigator, Mozilla Firefox, Opera and others, enable a user to selectively access web sites available over the Internet. Most computer users are familiar with such programs which run in an operating system environment with a window-style or graphical user interface and many use a browser almost continuously in their work. Other types of application programs include word processing, email, spreadsheet, and others.

Most browser programs have as a default that the program will, on initiation, direct the user to a preselected web site, often referred to as a “home page”. Indeed, most browsers have a function which enables a user to set the web site to which the browser is directed in initiation of execution. This default presupposes that a user has only a single web site which is most frequently accessed.

For many sophisticated users, this browser functionality is a limitation. Such users, sometimes also referred to as “power users”, frequently have lists of bookmarked web sites to which they frequently refer, and may prefer on initiating a browser session to have the session open to a web site other than the one stored in memory as the “home page” for that browser. A power user may have multiple sessions of a browser, or even multiple different browser programs, operating at the same time in order to provide near simultaneous access to a plurality of web sites.

Other application programs may have similar default characteristics, such as a word processing program opening to a blank document, an email program checking for mail on a particular mail server, and so forth.

### SUMMARY OF THE INVENTION

With the foregoing in mind, it is a purpose of this invention to provide a user with greater flexibility in the use of an application program. In realizing this purpose for the specific example of a browser program, a program is provided which offers a user a simple way to access alternatives to the “home page” web site on initiating operation of a browser program. In particular, a browser program in accordance with this invention offers a user the option of opening a session directly to the preselected “home page” web site or displaying a list of alternatives from which the user may select another web site as the site accessed as the browser program initiates.

With other application programs, the alternatives may be such as providing a user with the option of selecting a particular document to open in a word processing program or a particular mail server for an email program.

### BRIEF DESCRIPTION OF DRAWINGS

Some of the purposes of the invention having been stated, others will appear as the description proceeds, when taken in connection with the accompanying drawings, in which:

FIG. 1 is an elevation view of a computer system;

FIG. 2 is a schematic representation of a desktop display on the system of FIG. 1;

FIG. 3, 4 and 5 are views similar to FIG. 2; and

FIG. 6 is a view of a computer readable media on which a program in accordance with this invention is stored.

### DETAILED DESCRIPTION OF INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

The present invention may be implemented in a computer system, in a method of operating a computer system, and in the form of a program product distributed for use in a computer system.

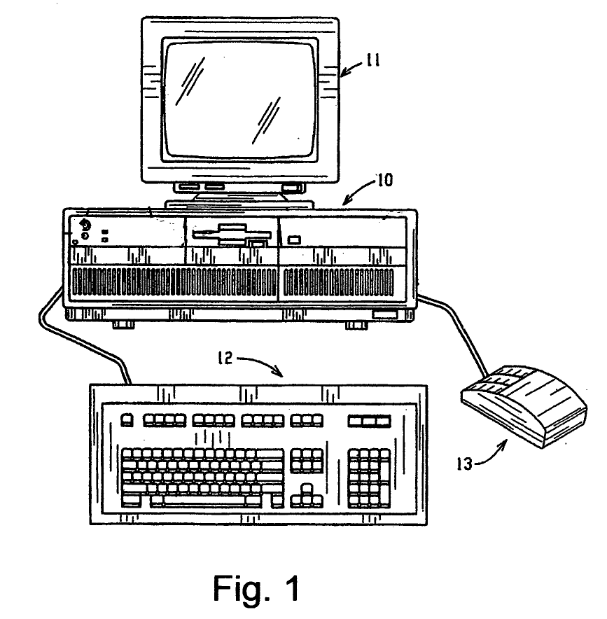

Turning first to implementation in a computer system, FIG. 1 illustrates a typical computer workstation, here a personal computer system 10. The system includes a central processor, memory accessible to the processor for storing data including programs to be executed, a display 11, and input devices including a keyboard 12 and a pointing device (here shown as a mouse 13). Such computer systems come in a variety of configurations, some known as notebook systems, others as desktop or deskside systems, some known as servers, and some known as “thin clients”. The present invention finds usefulness with any such systems, and it is to be understood that the choice of one type of such system for illustration is in no way limiting upon the implementation of this invention. Persons familiar with the arts of computer technology will easily recognize the scope of applicability of what is here described and illustrated.

It should be noted that a variety of pointing devices may be used with such a system. These can include a mouse (wired or wireless), a pointing stick such as a Trackpoint, a touch pad, a trackball and possibly other types of devices. Reference is made herein to a control signal originating from a pointing device as a “mouse click”, as that terminology has become well known. Notwithstanding that usage, it is to be understood that the control signal may be originated from the other types of pointing devices, as provision is always made with such devices for at least two control signals, conventionally known as a “left click” and a “right click” from the positioning of the relevant switches on a classic wired mouse.

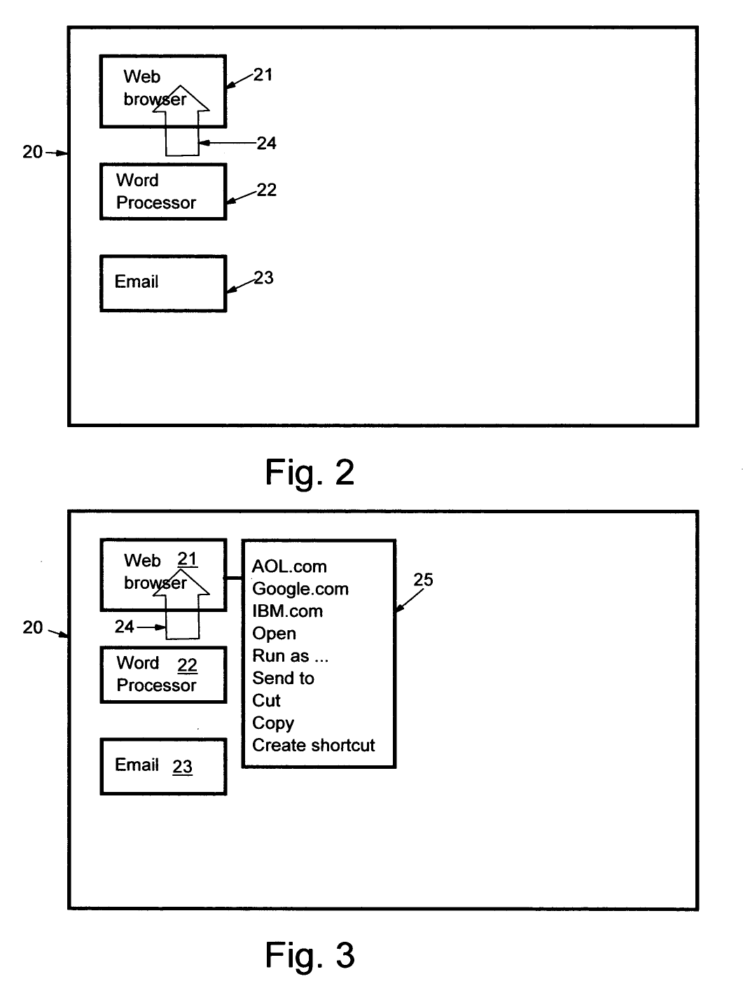

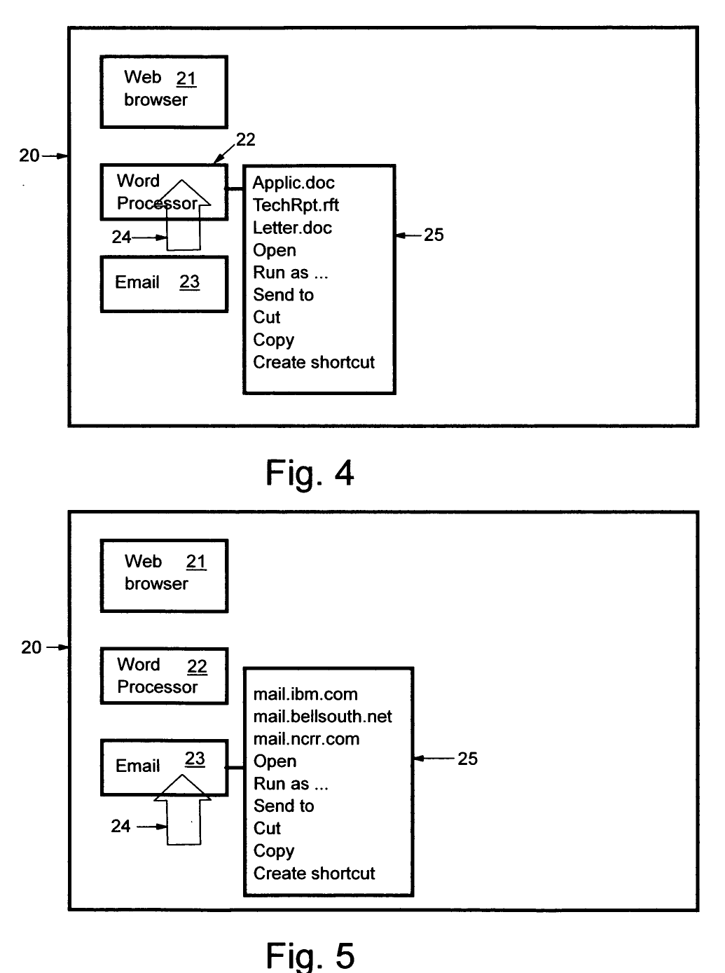

The system 10, as suggested, includes a monitor or display 11, on which information relevant to the operation of the system appears for the user. FIGS. 2 and 3 show views of what appears on the display 11 during use of this invention. Each of FIGS. 2 and 3 shows what has come to be called the “desktop” of the system while operating. Typically, and while running under a range of operating systems including for example only and not be way of limitation Microsoft Windows, Linux, Unix, OS/2 and others, the desktop displays to a user one or more icons, representing programs accessible to a user. The availability of such programs is usually indicated by the presence of an icon on the desktop, indicative of the possibility that a user may point to the icon, using the pointing device 13 to move a cursor over the icon, and then select the corresponding program for initiation by giving a starting signal. In most operating systems in general use, such a starting signal is a mouse click, performed by depressing a switch provided on the mouse 13. While described herein, this operation is generally known and widely used in current computer system operations.

As described above, the desktop display 20 provides a number of icons, typically selected by a software provider to represent their product. Here, such icons are represented by simple blocks, labeled as being for a web browser 21, a word processing program 21, and an email program 22. While the invention will here be described with particular reference to using an icon to initiate program execution, many window-style operating systems provide an alternate in the form of a program listing which may be identified in the manner of “All Programs” and which access program identifiers which here are also called icons. It is the intention of this invention that the functionality here described and illustrated may be applied to such an “All Programs” listing as well as to desktop access. Once an understanding of this invention is gained from the description and illustrations which follow, the “All Programs” implementation will become clear to the person of ordinary skill in the applicable arts.

Referring first to the icon for a web browser, FIG. 2 illustrates a step in the selection of the browser program for execution. The associated pointing device has been used to place a cursor 24 over the icon. At this point in the operation of many operating systems, a first signal such as a single left mouse click will selection the icon for activation. A following pair of left mouse clicks in quick succession (or alternatively, depressing the “Enter” key) will call the program for execution. The program will then open to the default display. With a web browser program, that display will be the web site preselected and stored as the home page.

Conventional operating systems provide an alternative in that a user, having selected an icon for activation as described above may use a second signal, commonly a right mouse click, to display beside the icon a menu box. Conventionally, that menu box provides a list of options, such as opening the program, deleting the icon, sending the icon to a different display, displaying the properties of the icon or program, and others.

The present invention modifies the alternative just described. More particularly and as shown in FIG. 3, the menu box 25 opened beside the icon displays a list of stored bookmarked web sites, enabling a user to select from that list and cause the browser program to open to a web site other than the stored home page.

FIGS. 4 and 5 illustrate similar operations for a word processing program and an email program. Selection of such a program would proceed as in FIG. 2 described above, and is not here shown specifically as it is believed well known.

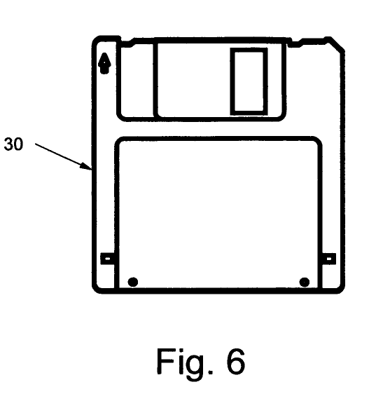

A program product as described here may be distributed on diskettes such as the diskette 30 of FIG. 6, or alternatively by other means to reach the memory of the system 10 of FIG. 1.

In the drawings and specifications there has been set forth a preferred embodiment of the invention and, although specific terms are used, the description thus given uses terminology in a generic and descriptive sense only and not for purposes of limitation.

We claim:

1. Apparatus comprising:
a computer system; and
an application program stored accessibly to and executing on said computer system;
said application program being effective to:
display an icon permitting selection of said program for execution;
respond to a selected one of first and second starting signals initiated by pointing device selection of said icon;
said first starting signal initiating execution of said program such that a preselected display is accessed; and
said second starting signal effecting display of a list of alternative displays from which a user selects one to be accessed as execution of said program initiates.

2. Apparatus according to claim 1 wherein said first starting signal is a selected one of a right mouse click and a left mouse click.

3. Apparatus according to claim 2 wherein said second starting signal is the other of a right mouse click and a left mouse click.

4. Apparatus according to claim 1 wherein said application program is a browser program, said preselected display is a home page, and said alternative displays are listed bookmarked web sites.

5. Apparatus according to claim 1 wherein said application program is a word processing program, said preselected display is a blank document, and said alternative displays are listed saved documents.

6. Apparatus according to claim 1 wherein said application program is an email program, said preselected display accesses a preferred mail server, an said alternative displays are alternative mail servers.

7. Method comprising:
providing an application program stored accessibly to and executable on a computer system;
displaying an icon on the computer system which permits selection of the application program by the computer system; and
responding to a selected one of first and second starting signals by initiating execution of the program;
said first starting signal initiating execution of the program such that a preselected web site is accessed; and
said second starting signal effecting display of a list of alternative displays from which a user selects one to be accessed as execution of the program initiates.

8. Method according to claim 7 wherein said first starting signal is a selected one of a right mouse click and a left mouse click.

9. Method according to claim 8 wherein said second starting signal is the other of a right mouse click and a left mouse click.

10. Method according to claim 7 wherein said application program is a browser program, said preselected display is a home page, and said alternative displays are listed bookmarked web sites.

11. Method according to claim 7 wherein said application program is a word processing program, said preselected display is a blank document, and said alternative displays are listed saved documents.

12. Method according to claim 7 wherein said application program is an email program, said preselected display accesses a preferred mail server, an said alternative displays are alternative mail servers.

13. Program Product comprising:
computer readable media; and
an application program stored on said media accessibly to a computer system and effective when executing on the computer system to:
display an icon on the computer system which permits selection of the program by the computer system; and
respond to a selected one of first and second starting signals by initiating execution of the program;
said first starting signal initiating execution of the program such that a preselected display is accessed; and
said second starting signal effecting display of a list of alternative displays from which a user selects one to be accessed as execution of the program initiates.

14. Program Product according to claim 13 wherein said first starting signal is a selected one of a right mouse click and a left mouse click.

15. Program Product according to claim 14 wherein said second starting signal is the other of a right mouse click and a left mouse click.

16. Program Product according to claim 13 wherein said application program is a browser program, said preselected display is a home page, and said alternative displays are listed bookmarked web sites.

17. Program Product according to claim 13 wherein said application program is a word processing program, said preselected display is a blank document, and said alternative displays are listed saved documents.

18. Program Product according to claim 13 wherein said application program is an email program, said preselected display accesses a preferred mail server, an said alternative displays are alternative mail servers.

19. Method comprising:
producing computer executable program code;
providing the program code to be deployed to and executed on a computer system;
the program code comprising instructions which are effective when executing on the computer system to:
display an icon on the computer system which permits selection of the program by the computer system; and
respond to a selected one of first and second starting signals by initiating execution of the program;
said first starting signal initiating execution of the program such that a preselected display is accessed; and
said second starting signal effecting display of a list of alternative displays from which a user selects one to be accessed as execution of the program initiates.
